(19) United States
(12) Patent Application Publication
(10) Pub. No.: US 2018/0164661 A1
(43) Pub. Date: Jun. 14, 2018

(54) CAMERA MODULE

(71) Applicant: Sharp Kabushiki Kaisha, Sakai City, Osaka (JP)

(72) Inventors: Yoshihiro SEKIMOTO, Sakai City (JP); Morikazu NAKATA, Sakai City (JP)

(21) Appl. No.: 15/577,828

(22) PCT Filed: May 25, 2016
(86) PCT No.: PCT/JP2016/065464

§ 371 Date: Nov. 29, 2017

(30) Foreign Application Priority Data
Jul. 13, 2015 (JP) 2015-139939

(51) Int. Cl. G03B 5/04; G02B 27/64; H02K 41/035; H02K 5/24

(52) U.S. Cl. CPC G03B 5/04; G02B 27/646; H02K 41/0356; G02B 7/09; G03B 2205/0015; G03B 2205/0069; H02K 5/24

(57) ABSTRACT

Accuracy of image stabilization is to be improved by reduction in a resonance peak. A coil (OIS coil 13) that is provided in one of a movable portion and a fixed portion (base 12) in a driving portion of a camera module (50) is arranged so as to be deviated to a side of a center of gravity (G) of the movable portion with a polarized surface (10a) of a permanent magnet (10), which is provided in the other, as a reference.

### TECHNICAL FIELD

The present invention relates to a camera module that is mounted on electronic equipment such as a cellular phone, and, particularly, relates to a camera module that includes an image stabilizer function.

### BACKGROUND ART

In recent years, most of cellular phones have been a model in which a camera module is embedded in a cellular phone. Particularly, a camera module of a type of having an autofocus (AF) function have been mounted on electronic equipment such as a cellular phone recently in most cases, and a case where a camera module further including an image stabilizer function is mounted is also increasing.

Most of image stabilizer mechanisms adopt a “barrel shift method” in which a lens barrel is driven in a direction vertical to an optical axis in accordance with magnitude of camera shake. Moreover, in most cases of the “barrel shift method”, displacement detection means by which a shift amount of a lens barrel is detected is included in order to perform image stabilization with high accuracy and feedback control is performed.

As such a mechanism that performs image stabilization of the “barrel shift method”, PTL 1 discloses a lens driving device that includes an image stabilizer portion by which an autofocus lens driving portion is driven in two directions each of which is orthogonal to an optical axis. The image stabilizer portion includes permanent magnetic pieces and image stabilizer coil portions fixed onto a base, and a surface of each of the image stabilizer coil portions, which intersects with a winding axis, faces a surface of each of the permanent magnet pieces, which intersects with a polarized surface, substantially in parallel. Moreover, the autofocus lens driving portion functions as an image stabilizer movable portion. Here, the “polarized surface” means an interface between a region of the N-pole and a region of the S-pole in each of the permanent magnet pieces.

Although a positional relation between the image stabilizer coil portions and the permanent magnet pieces is not particularly specified, by making determination from the drawings and the like, it is considered that the image stabilizer coil portions are arranged with respect to the permanent magnet pieces so that two winding axes are substantially symmetrical with the polarized surfaces of the facing permanent magnet pieces as a reference. Moreover, although a gravity center height of the image stabilizer movable portion is not specified, either, since a proportion of mass of a permanent magnet in an image stabilizer movable portion is normally large, it is considered that the center of gravity of the image stabilizer movable portion is at the center of optical axis, which is at the same height as a height near the center of the permanent magnet.

### CITATION LIST

### Patent Literature

PTL 1: Japanese Unexamined Patent Application Publication No. 2013-24944 (published on Feb. 4, 2013)

### SUMMARY OF INVENTION

### Technical Problem

Description will be given here for a phenomenon that occurs in a conventional camera module with reference to a relation of the permanent magnet pieces, the image stabilizer coil portions, and a center of gravity of the autofocus lens driving portion that are included in the lens driving device disclosed in PTL 1.

FIG. 13 is a view illustrating a relation of a permanent magnet 100, an image stabilizer coil 101, and a center of gravity G′ of a movable portion of an image stabilizer (not illustrated) which are included in the conventional camera module. As illustrated in FIG. 13, when current is applied to the image stabilizer coil 101, electromagnetic force acts on the image stabilizer coil 101 in a direction vertical to an optical axis in accordance with Fleming's left-hand rule.

Here, since the image stabilizer coil 101 is fixed to a base (not illustrated), with a reaction thereof, reaction force in the direction vertical to the optical axis acts on the permanent magnet 100 in a direction opposite to the electromagnetic force. Accordingly, rotational torque T′ resulting from the reaction force acts on the movable portion of the image stabilizer around the center of gravity G′.

FIG. 14 illustrates an example of frequency characteristics of the movable portion of the image stabilizer in a case where such rotational torque T′ acts. FIG. 14 is a Bode plot related to motion of the movable portion of the image stabilizer, which illustrates only gain characteristics. As illustrated in FIG. 14, a gain curve 102 includes primary resonance 103. The primary resonance 103 is resonance that is defined by mass of the movable portion of the image stabilizer and a spring constant of four suspension wires (not illustrated), and that occurs even when the rotational torque T′ does not acts.

Moreover, resonance 104 occurs with a frequency defined by the moment of inertia that occurs in the movable portion of the image stabilizer when the rotational torque T′ acts around the center of gravity G′, a spring constant of a spring (corresponding to an extending part of an upper plate spring in the lens driving device of PTL 1) which supports the movable portion of the image stabilizer, and the like.

In addition, in the conventional camera module, a lens holder is supported by a magnet holder, which is included in a driving portion of autofocus, via upper and lower plate springs (corresponding to the upper plate spring and a lower plate spring in the lens driving device of PTL 1) (none of which is illustrated). Thus, when the magnet holder rotates due to the action of the rotational torque T′, the lens holder is to rotate via the upper and lower plate springs, and moment is generated in the driving portion of autofocus. Then, resonance 105 occurs with a frequency defined by the moment of inertia of the driving portion of autofocus, a spring constant of the upper and lower plate springs that support the driving portion of autofocus, and the like.

Note that, each frequency of the aforementioned resonance is not defined only by a spring constant of a specific spring, but defined when a plurality of springs affect each other. Moreover, although the frequency of the resonance 105 is lower than the frequency of the resonance 104 in FIG. 14, the frequencies are inversed in some cases depending on design of the camera module. Furthermore, magnitude of a resonance peak is affected by a deviation amount between the center of gravity G′ and an acting position of force or the like, which acts on the permanent magnet, magnitude of a damping effect on a spring, etc.

Each of the aforementioned resonance is to cause reduction in servo performance of an image stabilizer portion. As above, the lens driving device disclosed in PTL 1 and the conventional camera module have a structure that may cause a resonance phenomenon, and there is a possibility that the servo performance of the image stabilizer portion is deteriorated. Thus, it is desired that the cause or the like of occurrence of the resonance phenomenon is removed or influence of the resonance phenomenon is reduced.

Note that, the lens driving device of PTL 1 and the conventional camera module relate to a camera module having an autofocus function. However, a similar problem occurs not only in the camera module having the autofocus function but also in a case where image stabilization is performed in a camera module of a fixed focus type, for example.

The invention has been made in view of the aforementioned problems, and an object thereof is to provide a camera module that has an image stabilizer function and is capable of performing image stabilization with high accuracy by improvement of servo performance by reducing a resonance peak.

### Solution to Problem

In order to solve the aforementioned problems, a camera module according to an aspect of the invention includes: an imaging lens; and a driving portion that moves the imaging lens in a direction vertical to an optical axis, in which the driving portion includes a movable portion on which the imaging lens is mounted and a fixed portion which is not displaced at a time of image stabilization, a permanent magnet is included in one of the movable portion and the fixed portion and a coil is included in the other one of the movable portion and the fixed portion, one magnetic pole of the permanent magnet faces the optical axis, a surface of the coil, which is orthogonal to a winding axis of the coil, faces a surface of the permanent magnet, which is orthogonal to a polarized surface of the permanent magnet and substantially vertical to the optical axis, in parallel, and the coil is arranged to be deviated to a side of a center of gravity of the movable portion with the polarized surface as a reference.

### Advantageous Effects of Invention

According to an aspect of the invention, by offsetting rotational torque acting around a center of gravity of a movable portion at least at a certain degree, it is possible to reduce a resonance peak of a resonance phenomenon that occurs as a result of the rotational torque. Thus, a camera module according to the aspect of the invention is capable of performing image stabilization with high accuracy by improvement of servo performance of a driving portion.

### BRIEF DESCRIPTION OF DRAWINGS

FIG. 1 is a perspective view schematically illustrating a schematic configuration of a camera module according to Embodiment 1 of the invention.

FIG. 2 is a cross sectional view of the camera module illustrated in FIG. 1, which is taken along an A-A line and viewed from a direction of arrows.

FIG. 3 is a cross sectional view of the camera module illustrated in FIG. 2, which is taken along a B-B line and viewed from a direction of arrows.

FIG. 4 is a cross sectional view of a main part, which illustrates an example of a positional relation of a pair of permanent magnets and OIS coils which are included in the camera module illustrated in FIG. 2.

FIG. 5 is a Bode plot related to motion of an OIS movable portion included in the camera module according to Embodiment 1 of the invention, which illustrates only gain characteristics.

FIG. 6 is a cross sectional view of a main part, which illustrates an example of a positional relation of a pair of permanent magnets and OIS coils which are included in a camera module according to Embodiment 2 of the invention.

FIG. 7 is a cross sectional view of the main part, which illustrates a state in which the pair of permanent magnets are displaced in a direction of an arrow from the positional relation of FIG. 6.

FIG. 8 is a cross sectional view of a main part, which illustrates an example of a positional relation of a pair of permanent magnets and OIS coils which are included in a camera module according to Embodiment 3 of the invention.

FIG. 9 is a cross sectional view of the main part, which illustrates a state in which the pair of permanent magnets are displaced in a direction of an arrow from the positional relation of FIG. 8.

FIG. 10 is a cross sectional view schematically illustrating a schematic configuration of a camera module according to Embodiment 4 of the invention.

FIG. 11 is a cross sectional view of a main part, which illustrates an example of a positional relation of a pair of permanent magnets and OIS coils which are included in the camera module illustrated in FIG. 10.

FIG. 12 is a cross sectional view schematically illustrating a schematic configuration of a camera module according to Embodiment 5 of the invention.

FIG. 13 is a cross sectional view of a main part, which illustrates a relation of a permanent magnet, an image stabilizer coil, and a center of gravity of a movable portion of an image stabilizer which are included in a conventional camera module.

FIG. 14 is a Bode plot related to motion of the movable portion of the image stabilizer included in the conventional camera module, which illustrates only gain characteristics.

### DESCRIPTION OF EMBODIMENTS

### Embodiment 1

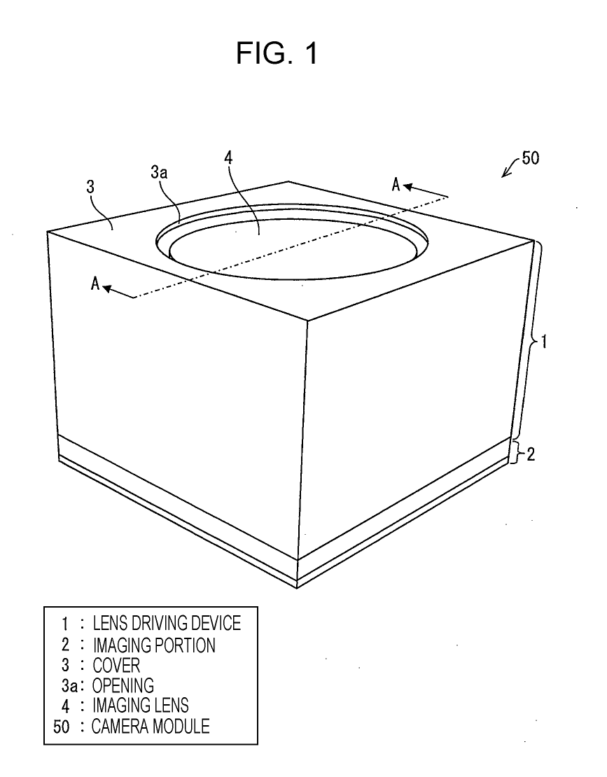

Hereinafter, an embodiment of the invention will be described in detail with reference to FIG. 1 to FIG. 5.

Note that, in the present embodiment, description will be given by taking, as an example, a camera module having an optical image stabilizer (OIS) function and an autofocus (AF) function. The same will be applied also to Embodiment 2 to Embodiment 5.

### <Configuration of Camera Module>

First, an entire structure of a camera module 50 will be described on the basis of FIG. 1. FIG. 1 is a perspective view schematically illustrating a schematic configuration of the camera module 50 of the present embodiment.

As illustrated in FIG. 1, the camera module 50 includes: a lens driving device 1 that includes an imaging lenses 4; an imaging portion 2; and a cover 3 that covers the lens driving device 1. The lens driving device 1 and the imaging portion 2 are arranged and stacked in a direction of an optical axis 4a of the imaging lenses 4 (hereinafter, briefly referred to as the optical axis 4a) from the imaging portion 2 in this order.

Note that, for convenience, description will be hereinafter given by setting that a side of the lens driving device 1 (side of an object) is an upper side and a side of the imaging portion 2 is a lower side. However, the aforementioned definition does not prescribe an upper-and-lower direction of the camera module 50 when being used, and the upper and lower sides may be inversed, for example. In addition, when viewing each of the drawings, it is set that the left is a left side and the right is a right side with the optical axis 4a as a reference.

The cover 3 has a box-like shape that covers the imaging portion 2, the lens driving device 1, and the imaging lenses 4 from the upper side of the imaging lenses 4. An opening 3a is provided in the cover 3 at a position corresponding to the upper side of the imaging lenses 4. An inner side of the cover 3 may be colored black which does not reflect light.

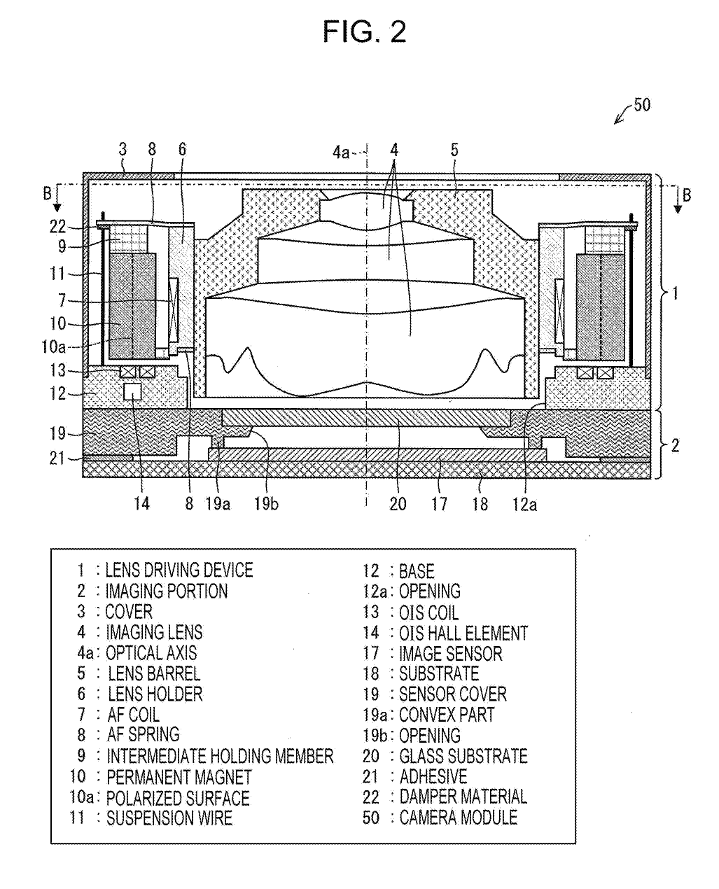

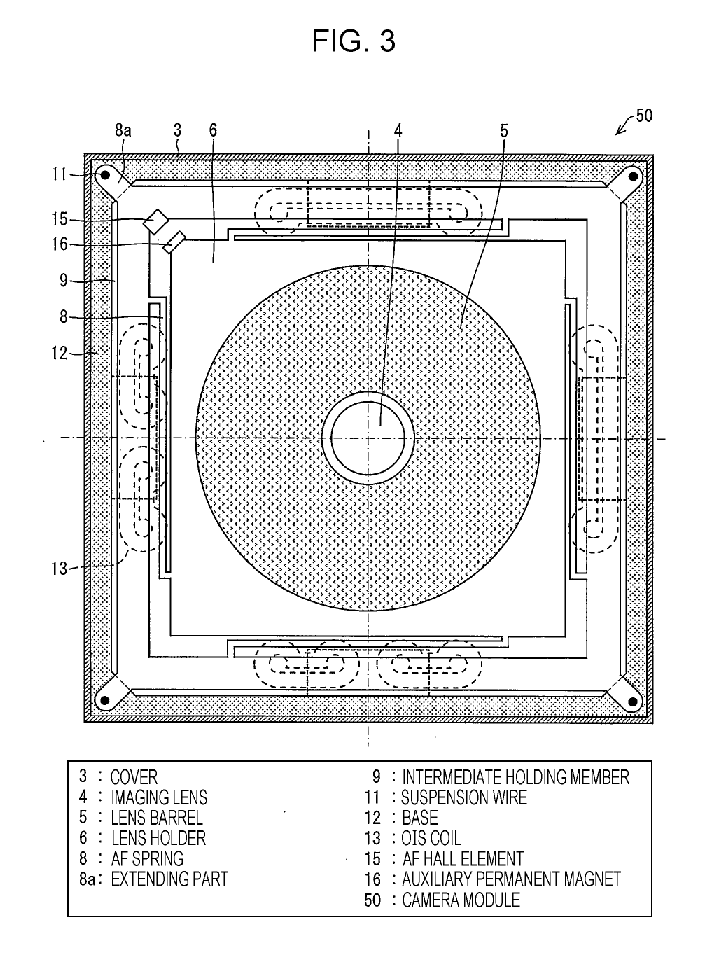

Next, a structure of each portion of the camera module 50 will be described on the basis of FIG. 2 and FIG. 3. FIG. 2 is a cross sectional view of the camera module 50 illustrated in FIG. 1, which is taken along an A-A line and viewed from a direction of arrows, and a cross sectional view obtained by cutting a center part of the camera module 50 along the direction of the optical axis 4a. FIG. 3 is a cross sectional view of the camera module 50 illustrated in FIG. 2, which is taken along a B-B line and viewed from a direction of arrows, and a cross sectional view obtained by cutting a space between the inner side of the cover 3 and an upper surface of a lens barrel 5 described below in a direction vertical to the optical axis 4a.

### <Configuration of Lens Driving Device>

The lens driving device 1 is a device by which the imaging lenses 4 are driven in two directions of the direction of the optical axis 4a and the direction vertical to the optical axis 4a. As illustrated in FIG. 2, the lens driving device 1 includes the plurality of (in FIG. 2, three) imaging lenses 4, the lens barrel 5, a lens holder 6, and an AF coil 7 wound around the lens holder 6. The plurality of imaging lenses 4, the lens barrel 5, the lens holder 6, and the AF coil 7 function as an AF movable portion that is movable (that is, position of which is changed) in the direction of the optical axis 4a at a time of autofocus.

The imaging lenses 4 guide light from an outside to an image sensor 17 (described below) included in the imaging portion 2. An axis of the image sensor 17 is coincident with the optical axis 4a of the imaging lenses 4.

The lens barrel 5 holds the plurality of (in FIG. 2, three) imaging lenses 4 in an inside thereof. An axis of the lens barrel 5 is also coincident with the optical axis 4a. In the present embodiment, one that has an external form in a columnar shape is used as the lens barrel 5, but there is no limitation thereto, and one that has an external form in a rectangular parallelepiped shape may be used, for example.

The lens holder 6 is supported by AF springs 8, which are arranged in a pair in an upper part and a lower part of the lens holder 6 with a predetermined space therebetween, so as to be movable in the direction of the optical axis 4a with respect to an intermediate holding member 9.

Note that, the lens barrel 5 and the lens holder 6 may be fixed with an adhesive (not illustrated) or fixed with a screw or the like. Moreover, they may be used in combination.

The AF coil 7 is arranged in an outer side surface of the lens holder 6 and fixed. The AF coil 7 is wound substantially in a quadrilateral so as to surround the lens barrel 5. An axis of the AF coil 7 is coincident with the optical axis 4a.

Permanent magnets 10 are arranged so as to face outer side surfaces of the AF coil 7 which is wound substantially in the quadrilateral. The permanent magnets 10 are used in common for AF and OIS, and function as dual-purpose magnets. The permanent magnets 10 are arranged so that magnetic poles of the permanent magnets 10 facing each other, which have the mutually same polarity, are directed toward the optical axis 4a (that is, so that the magnetic poles having the same polarity face the AF coil 7).

Furthermore, lower surfaces of the permanent magnetics 10 are surfaces each of which is orthogonal to each of polarized surfaces 10a of the permanent magnets 10 and vertical to the optical axis 4a, and face upper surfaces of OIS coils (coils) 13 described below. Here, the “polarized surface” means an interface between a region of the N-pole and a region of the S-pole in the permanent magnet 10.

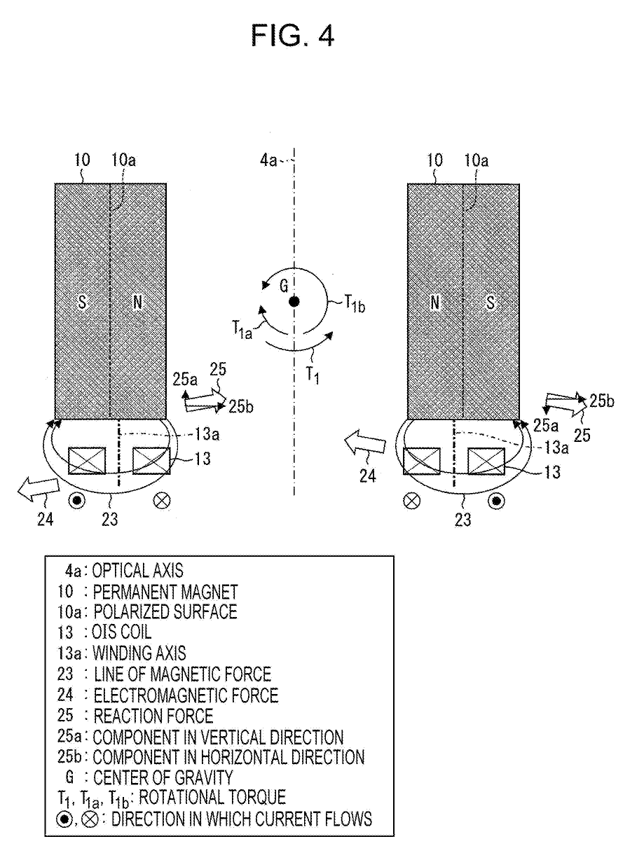

Although the permanent magnets 10 are arranged so that each N-pole is directed to a side of the optical axis 4a in the present embodiment (refer to FIG. 4 and the like), each S-pole may be directed to the side of the optical axis 4a, for example. In other words, the permanent magnets 10 are only required to have one of the magnetic poles facing the optical axis 4a.

In such a configuration described above, when current is applied to the AF coil 7, electromagnetic force that is generated between the AF coil 7 and the permanent magnets 10 acts on the lens holder 6, and the lens holder 6, the lens barrel 5 that is integrally fixed thereto, and the like are subjected to AF drive. That is, the AF coil 7 and the permanent magnets 10 function as an AF driving portion that drives the imaging lenses 4 in the direction of the optical axis 4a for autofocus.

Each of the AF springs 8 is a spring which is made of metal and widely used in an existing camera module with an AF function. The AF springs 8 are arranged so as to surround the lens barrel 5.

In the AF springs 8 which are provided in a pair, an inner end part of the AF spring 8 arranged in the upper side is fixed to the upper part of the lens holder 6, and an outer end part of the AF spring 8 arranged in the upper side is fixed to the intermediate holding member 9. An inner end part of the AF spring 8 arranged in the lower side is fixed to the lower part of the lens holder 6, and an outer end part of the AF spring 8 arranged in the lower side is fixed to the intermediate holding member 9. The permanent magnets 10 are fixed to the intermediate holding member 9.

The AF springs 8 support the lens holder 6 so as to be movable in an up-and-down direction, and may support the lens holder 6 so as to be movable in both up and down directions in a state where current does not flow through the AF coil 7, or may apply downward force with the lens holder 6 and the intermediate holding member 9 abutting to each other. At a lowest side of a movable range of the lens holder 6, at least a part (lower end) of the lens barrel 5 is inserted into an opening 12a, which is provided in a center part of a base (fixed portion) 12, to thereby achieve reduction in thickness of the camera module 50.

Moreover, the AF spring 8 has extending parts 8a each of which protrudes as far as an outer side of the intermediate holding member 9 described below, and an upper end of each of suspension wires 11 is fixed to each of the extending parts 8a. The upper end of each of the suspension wires 11 is connected to each of the extending parts 8a of the AF spring 8 not only for using the AF spring 8 and the suspension wires 11 as current carrying means of the AF coil 7 or the like to thereby perform electrical connection but also for causing the extending parts 8a to act as a shock absorber function of the suspension wires 11. When the suspension wires 11 receives great stress due to a dropping impact or the like, the extending parts 8a bend and suppress a deformation amount of the suspension wires 11, so that it is possible to prevent occurrence of tensile fracture or buckling.

On the other hand, a lower end of each of the suspension wires 11 is fixed to the base 12. Note that, the lower end of each of the suspension wires 11 may be fixed to a substrate (not illustrated) connected to the base 12. By connecting the lower end to the substrate, electrical connection for carrying current is facilitated.

The intermediate holding member 9 is supported by the four suspension wires 11 with respect to the base 12 so as to be movable in the direction vertical to the optical axis 4a. Moreover, the permanent magnets 10 are fixed to a lower part of the intermediate holding member 9.

The base 12 is a rectangular member having the opening 12a into which a part of the lens barrel 5 is able to be inserted in the direction of the optical axis 4a, and OIS coils 13 are fixed to an upper surface thereof and OIS hall elements 14 described below are fixed in an inside thereof. The base 12 functions as both an AF fixed portion and an OIS fixed portion (fixed portion) each of which does not change a position thereof even at a time of autofocus or at a time of image stabilization.

The OIS coils 13 are fixed to the base 12 so as to face lower surfaces of the permanent magnets 10, and arranged in four sides of the lens driving device 1. Specifically, the OIS coils 13 are arranged so that each of upper surfaces thereof, which is orthogonal to each of winding axes 13a of the OIS coils 13, faces each of the lower surfaces of the permanent magnets 10 in parallel.

The OIS coils 13 which are arranged in two facing sides of the base 12 are paired and used for driving an OIS movable portion in one direction. Moreover, another pair of OIS coils 13 are arranged in the other facing two sides, and used for driving the OIS movable portion in a different direction.

Furthermore, as illustrated in FIG. 3, one of each pair of OIS coils 13 is divided into two. A direction of a virtual division line (not illustrated) of the division into two is coincident with a direction substantially vertical to the polarized surface 10a of the permanent magnet 10. By dividing the OIS coil 13 into two and arranging the OIS hall element 14 near a middle position between the two-divided OIS coils 13 in this manner, it is possible to reduce influence of magnetic field noise generated in the OIS coil 13. However, it is not always necessary to divide only one of the pair of OIS coils 13 into two, and, for example, both of the pair of OIS coils 13 may be divided into two. Alternatively, as long as a position at which the OIS hall element 14 is arranged is able to be contrived, it is not necessary to divide either of them into two.

Note that, a cross section of the OIS coil 13 divided into two is not able to be grasped in a case where the camera module 50 is cut at a position of the division into two, so that FIG. 2 illustrates the view obtained by cutting the camera module 50 at a position at which the cross section of the OIS coil 13 divided into two appears.

In such a configuration described above, when current is applied to the OIS coils 13, electromagnetic force is generated between each of the OIS coils 13 and each of the permanent magnetics 10. Then, with an action of the electromagnetic force, the intermediate holding member 9, the lens holder 6 coupled thereto via the AF springs 8, the lens barrel 5, and the like are subjected to OIS drive. That is, in addition to the AF movable portion, the intermediate holding member 9 and the permanent magnets 10 are driven in the direction vertical to the optical axis 4a as the OIS movable portion (movable portion). Then, the OIS movable portion and the OIS fixed portion constitute an OIS driving portion (driving portion).

Note that, in the present embodiment, the permanent magnets 10 and the OIS coils 13 are provided in the OIS movable portion and the base 12, respectively, but the arrangement of the permanent magnets 10 and the OIS coils 13 may be inversed. In other words, the permanent magnets 10 may be provided in one of the OIS movable portion and the base 12 and the OIS coils 13 may be provided in the other.

Moreover, each of the OIS hall elements (displacement detection portions) 14 by which a position of the OIS movable portion (OIS displacement amount) with respect to the image sensor 17 is detected is fixed in the inside of the base 12 so as to be arranged near each middle position of the OIS coil 13 divided into two. In other words, the OIS hall element 14 detects a displacement amount of the imaging lenses 4 in the direction vertical to the optical axis 4a. The displacement amount corresponds to the OIS displacement amount.

Although only one is illustrated in FIG. 2, the OIS hall elements 14 are arranged in two sides in order to detect displacement in two directions. The other hall element 14 which is not illustrated only needs to be arranged in an inside of either of two sides which intersect with two sides of the base 12, cross sections of which are illustrated in FIG. 2.

In this manner, since the OIS coils 13 and the OIS hall elements 14 are fixed to the base 12 in a state of facing each other, it becomes easier to carry current compared with a case where they are arranged on a side of the OIS movable portion. Moreover, since it is possible to appropriately control the OIS displacement amount and a movement direction of the OIS movable portion by the OIS hall elements 14 in accordance with an amount and a direction of shake, it is possible to enhance stabilization accuracy of image stabilization.

Furthermore, the camera module 50 also includes an AF hall element 15 by which a displacement amount of the AF movable portion is detected. As illustrated in FIG. 3, the AF hall element 15 is fixed to the intermediate holding member 9 arranged in a corner part of the lens driving device 1. Moreover, an auxiliary permanent magnet 16 is provided in a corner part of the lens holder 6 so as to face the AF hall element 15.

The auxiliary permanent magnet 16 is displaced relative to the AF hall element 15 in accordance with drive of the AF movable portion, so that it is possible to detect the displacement amount of the AF movable portion.

Note that, in the present embodiment, the AF hall element 15 and the auxiliary permanent magnet 16 are fixed to the intermediate holding member 9 and the lens holder 6, respectively, but the arrangement may be inversed. Moreover, in order to carry current to the AF hall element 15, the camera module 50 may include six or more suspension wires 11.

For example, in a case where six suspension wires 11 are included, four are used for carrying current to the AF hall element 15, and two are used for carrying current to the AF coil 7.

### <Configuration of Imaging Portion>

The imaging portion 2 images light that passes through the imaging lenses 4. As illustrated in FIG. 2, the imaging portion 2 includes the image sensor 17, a substrate 18, a sensor cover 19, and a glass substrate 20.

The image sensor 17 is mounted on the substrate 18, receives light, which reaches via the imaging lenses 4, to perform photoelectric conversion, and obtains an object image formed on the image sensor 17.

The substrate 18 and the sensor cover 19 are bonded and fixed in a state where a gap generated between an upper surface of the substrate 18 and a lower surface of the sensor cover 19 is filled with an adhesive 21.

The sensor cover 19 is a rectangular member which is arranged on a lower side of the base 12 and mounted on the image sensor 17 so as to cover an entirety of the image sensor 17, and a convex part 19a which is in contact with the image sensor 17 is provided on a bottom surface side of the sensor cover 19. Moreover, the sensor cover 19 has, in a center part thereof, an opening 19b which passes therethrough in the up-and-down direction.

As above, a tip surface of the convex part 19a is in contact with the image sensor 17, so that positional accuracy of the imaging lenses 4 with respect to the image sensor 17 in the direction of the optical axis 4a is improved.

The opening 19b is closed by the glass substrate 20. A material of the glass substrate 20 is not limited, and may include an infrared ray cutting function, for example.

Note that, as illustrated in FIG. 2, a damper material 22 such as, for example, an ultraviolet curable gel is applied to a connecting part of the suspension wire 11 and the extending part 8a of the AF spring 8. Description for the damper material 22 will be given below.

### <Positional Relation of Permanent Magnets and OIS Coils>

Next, a positional relation of the permanent magnets 10 and the OIS coils 13 will be described with reference to FIG. 4. FIG. 4 is a cross sectional view of a main part, which illustrates an example of the positional relation of a pair of permanent magnets 10 and the OIS coils 13 which are included in the camera module 50 according to the present embodiment.

As illustrated in FIG. 4, in a case where the pair of permanent magnets 10 are magnetized so that N-poles thereof face each other (N-poles thereof face the optical axis 4a), a line of magnetic force 23 is directed from each N-pole to each S-pole as indicated with an arrow in the figure.

Here, the winding axis 13a of the OIS coil 13 is deviated to a side of a center of gravity G of the OIS movable portion with respect to the polarized surface 10a of the permanent magnet 10, in other words, the OIS coil 13 is arranged so as to be deviated to the side of the center of gravity G of the OIS movable portion with the polarized surface 10a as a reference, so that a large number of magnetic flux components which are inclined with respect to the polarized surface 10a enter a coil winding part particularly on the side of the center of gravity G. Accordingly, electromagnetic force 24 which is generated when current is applied to the OIS coil 13 also acts in a direction inclined with respect to the direction vertical to the optical axis 4a (hereinafter, referred to as a horizontal direction). In other words, in a case where a first half side and a second half side of the OIS coil 13 are arranged symmetrically with respect to the polarized surface 10a, components of force of the electromagnetic force 24 in the direction of the optical axis 4a in the first half side and the second half side offset each other even when the inclined magnetic flux components enter, but, in a case where the arrangement is deviated, components of the force in the direction of the optical axis 4a remain without being able to be offset.

For example, in a case where current in such a direction illustrated in FIG. 4 is applied to the OIS coil 13, the electromagnetic force 24 which is inclined to a left direction and a lower side with respect to the horizontal direction acts on the OIS coil 13 which is positioned in a left side with the optical axis 4a as a reference. On the other hand, the electromagnetic force 24 which is inclined to the left direction and an upper side with respect to the horizontal direction acts on the OIS coil 13 which is positioned in a right side with the optical axis 4a as the reference.

In this case, since the OIS coils 13 are fixed to the base 12, reaction force 25 acts on the permanent magnets 10 due to reaction of the electromagnetic force 24. Specifically, the reaction force 25 which is inclined to a right direction and the upper side with respect to the horizontal direction acts on a lower end part of the permanent magnet 10 which is positioned in the left side with the optical axis 4a as the reference. On the other hand, the reaction force 25 which is inclined to the right direction and the lower side with respect to the horizontal direction acts on a lower end part of the permanent magnet 10 which is positioned in the right side with the optical axis 4a as the reference.

As illustrated in FIG. 4, the reaction force 25 acts on each of the permanent magnets 10 as a component 25b in the horizontal direction and a component 25a in the direction of the optical axis 4a (hereinafter, referred to as the vertical direction). Among the components, each of the components 25b in the horizontal direction, which acts on each of the pair of permanent magnets 10, generates rotational torque T1b which is counterclockwise about the center of gravity G of the OIS movable portion. On the other hand, each of the components 25a in the vertical direction, which acts on each of the pair of permanent magnets 10, generates rotational torque T1a which is clockwise about the center of gravity G.

In this manner, two types of rotational torque are opposite to each other, and act on the center of gravity G of the OIS movable portion and offset each other. Accordingly, rotational torque T1 which (is counterclockwise in the present embodiment and) has been reduced at a certain degree acts on the center of gravity G in the end. Thus, it is possible to reduce a resonance peak of a resonance phenomenon that occurs as a result of the rotational torque which acts on the center of gravity G of the OIS movable portion.

### <Frequency Characteristics of OIS Movable Portion>

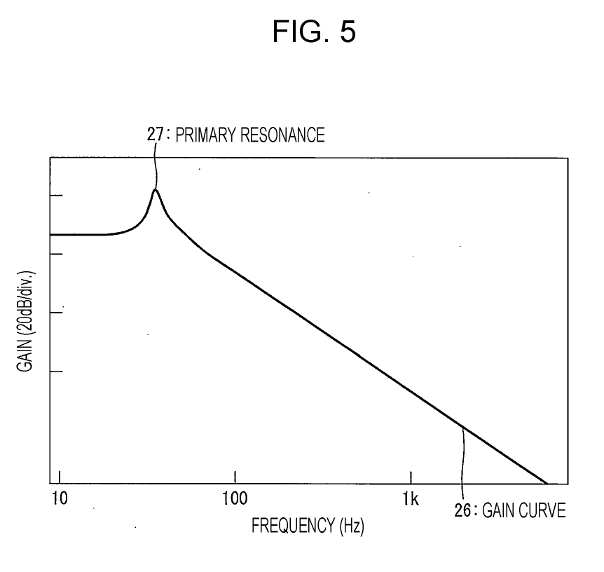

Next, with reference to FIG. 5, description will be given to an example of frequency characteristics of the OIS movable portion in a case where the rotational torque T1 acts on the center of gravity G of the OIS movable portion. FIG. 5 is a Bode plot related to motion of the OIS movable portion included in the camera module 50, which illustrates only gain characteristics.

As illustrated in FIG. 5, a gain curve 26 includes primary resonance 27, but there is no resonance phenomenon resulting from a rotation mode, which occurs in a higher band than the primary resonance 27, and gain changes substantially at −40 dB/dec. Note that, actually, there is a possibility that a resonance peak of the rotation mode does not disappear completely as in the example. However compared with a conventional technique, it is possible to reduce the resonance peak at least at a certain degree and provide a wider servo band, thus making it possible to realize high-performance image stabilization. Note that, in a case where a resonance phenomenon is caused by a factor other than the rotation mode, other measures such as, for example, measures with a circuit filter are required.

<Reduction Measures of Resonance Peak with Damper Material>

As illustrated in FIG. 2, resonance peak reduction measures in which a damping effect with the damper material 22 is utilized are taken for the camera module 50. Specifically, the damper material 22 such as, for example, an ultraviolet curable gel is applied to the connecting part of the suspension wire 11 and the extending part 8a of the AF spring 8.

In the present embodiment, the intermediate holding member 9 also performs rotational motion due to the action of the rotational torque T1 (refer to FIG. 4), so that a resonance phenomenon of the rotation mode occurs as a result of the rotational motion. However, vibrations of the extending part 8a, which occur as a result of the resonance phenomenon, are suppressed by the damper material 22, so that it is possible to reduce a resonance peak of a resonance phenomenon resulting from the vibrations.

Note that, a place to which the damper material 22 is applied is not limited to that of the above-described case, and, for example, also by filling in a gap between the permanent magnet 10 and the OIS coil 13 with the damper material 22, it is possible to suppress vibrations of the permanent magnet 10 and the intermediate holding member 9.

Moreover, there is a possibility that the vibrations of the extending part 8a, which result from the rotational motion of the intermediate holding member 9, are transmitted to the lens holder 6 via the AF spring 8 and a mode in which the lens holder 6 also performs rotational motion and the AF spring 8 resonates also occurs. However, by suppressing the vibrations of the intermediate holding member 9 by the damper material 22 as described above, it is possible to achieve a damping effect on the mode as well.

### Embodiment 2

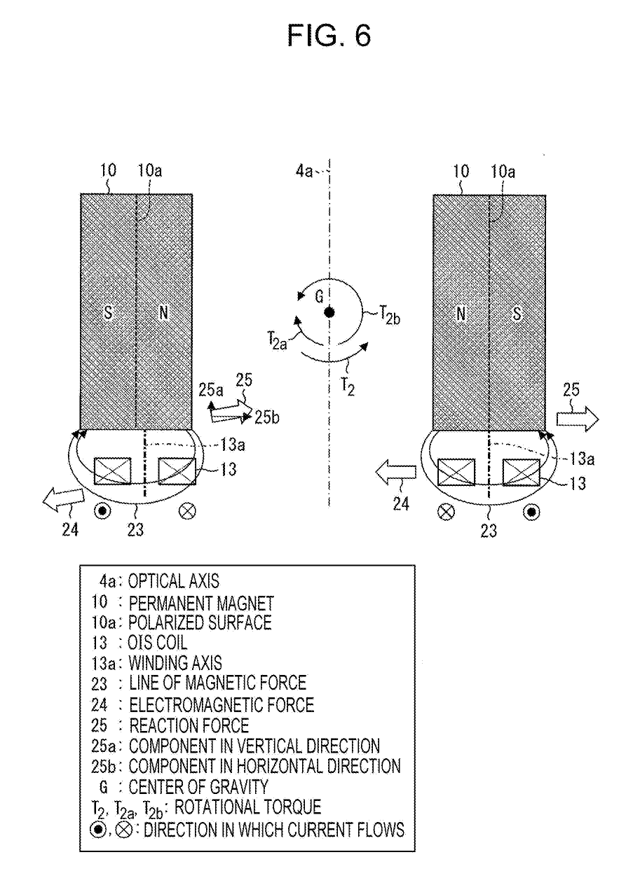

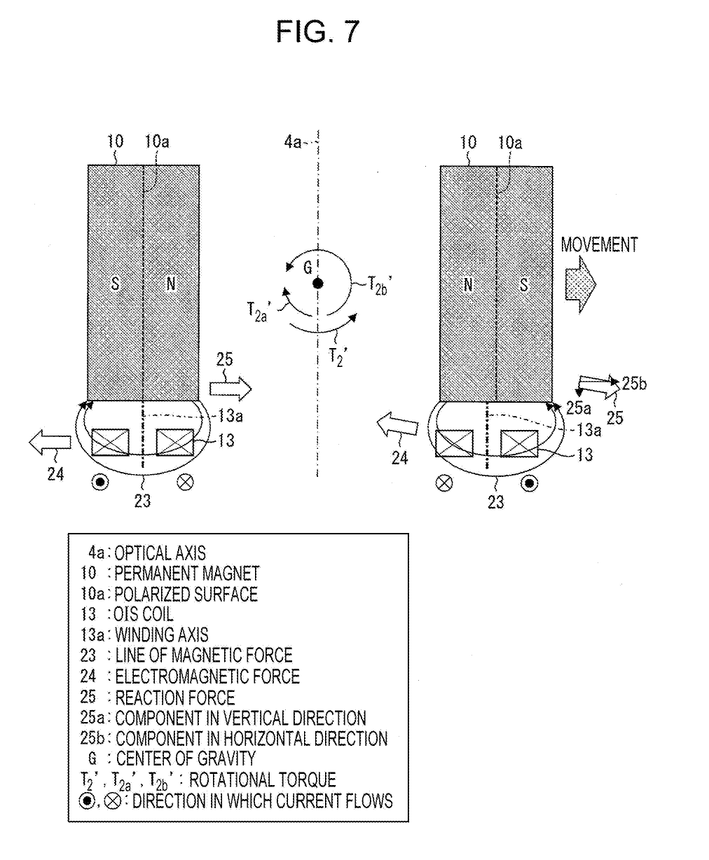

Another embodiment of the invention will be described as follows on the basis of FIG. 6 and FIG. 7. Note that, for convenience of description, the same reference signs will be assigned to members having the same functions as those of the members described in Embodiment 1 above, and description thereof will be omitted.

### <Positional Relation of Permanent Magnets and OIS Coils>

First, a positional relation of the permanent magnets 10 and the OIS coils 13 which are included in the camera module 50 according to Embodiment 2 of the invention will be described with reference to FIG. 6. FIG. 6 is a cross sectional view of a main part, which illustrates an example of the positional relation of a pair of permanent magnets 10 and the OIS coils 13 which are included in the camera module 50 according to the present embodiment.

The camera module 50 according to the present embodiment is different from the camera module 50 according to Embodiment 1 in that, as illustrated in FIG. 6, the winding axis 13a of the OIS coil 13 is deviated to the side of the center of gravity G of the OIS movable portion with respect to the polarized surface 10a of the permanent magnet 10 only in the permanent magnet 10 and the OIS coil 13 in the left side. In this manner, a position of the OIS coil 13 may be deviated to the center of gravity G with respect to the permanent magnet 10 only in one side.

First, the positional relation of the permanent magnet 10 and the OIS coil 13 in the left side in FIG. 6 is the same as the positional relation of the permanent magnet 10 and the OIS coil 13 in the left side in FIG. 4. In a case where, in the positional relation, current is applied to the OIS coil 13 in a direction illustrated in the figure, the reaction force 25 generated in the lower end part of the permanent magnet 10 acts on the permanent magnet 10 as the component 25a in the vertical direction and the component 25b in the horizontal direction. Then, the component 25a in the vertical direction gives rotational torque T2a which is clockwise about the center of gravity G of the OIS movable portion and the component 25b in the horizontal direction gives rotational torque which is counterclockwise about the center of gravity G, and the two types of torque offset each other.

On the other hand, in the positional relation of the permanent magnet 10 and the OIS coil 13 in the right side in FIG. 6, the polarized surface 10a of the permanent magnet 10 and the winding axis 13a of the OIS coil 13 are in a state of being on the same plane. Accordingly, since the reaction force 25 which acts on the permanent magnet 10 in the right side does not have a component in the vertical direction, the reaction force 25 itself gives rotational torque which is counterclockwise about the center of gravity G of the OIS movable portion.

Note that, a sum of the counterclockwise rotational torque which is generated on the basis of the component 25b in the horizontal direction in the left side and the counterclockwise rotational torque which is generated on the basis of the component 25b in the horizontal direction in the right side is rotational torque T2b which is counterclockwise.

As above, (counterclockwise) rotational torque T2 which is obtained by offsetting the rotational torque T2b with the rotational torque T2a at a certain degree acts on the center of gravity G of the OIS movable portion in the end. Thus, it is possible to reduce a resonance peak of a resonance phenomenon that results from the rotational torque which acts on the center of gravity G.

Next, description will be given to another effect that is obtained by setting, only in one side, the position of the OIS coil 13 to be deviated to the center of gravity G of the OIS movable portion with respect to the permanent magnet 10.

The component 25a in the vertical direction which acts on the permanent magnet 10 also serves as force with which the OIS movable portion is caused to perform translation motion in the direction of the optical axis 4a. Accordingly, there is a possibility that the extending part 8a of the AF spring 8 in the upper side resonates due to the component 25a in the vertical direction and a new resonance peak is generated. Here, since the OIS movable portion is controlled on the basis of a detection signal of the OIS hall element 14, in a case where the OIS hall element 14 does not detect displacement in the direction of the optical axis 4a, which is based on the vibrations, it is possible to reduce influence on servo performance of the OIS driving portion.

However, the OIS hall element 14 basically detects also the displacement of the permanent magnet 10 in the direction of the optical axis 4a. The displacement of the permanent magnet 10 in the direction of the optical axis 4a does not contribute to image stabilization, so that the OIS hall element 14 performs erroneous detection of the displacement in the direction of the optical axis 4a as displacement in the direction vertical to the optical axis 4a.

In this respect, since the component 25a in the vertical direction does not act on the permanent magnet 10 in the right side in the present embodiment, a displacement amount in the direction of the optical axis 4a is small in a right part of the OIS movable portion. Accordingly, by arranging the OIS hall element 14 at a position facing the lower surface of the permanent magnet 10 in the right side, it is possible to reduce the displacement amount in the direction of the optical axis 4a, which is detected by the OIS hall element 14, thus making it possible to lower an erroneous displacement detection signal level.

Thus, in order to obtain such an effect above, it is desired that the OIS hall element 14 is arranged in a side in which the position of the OIS coil 13 is not deviated to the center of gravity G of the OIS movable portion with respect to the permanent magnet 10.

<Positional Relation of Permanent Magnets and OIS Coils after OIS Drive>

Next, description will be given to a positional relation of the permanent magnets 10 and the OIS coils 13 after OIS drive with reference to FIG. 7. FIG. 7 is a cross sectional view of the main part, which illustrates a state in which the pair of permanent magnets 10 are displaced in a direction of an arrow in the figure from the positional relation illustrated in FIG. 6.

In a case where, in the positional relation of the pair of permanent magnets 10 and the OIS coils 13 illustrated in FIG. 6, current is applied to the pair of OIS coils 13 in a direction illustrated in the figure, the pair of permanent magnets 10 are displaced in the direction of the arrow (right side) by OIS drive. In a state after the displacement, the positional relation of the permanent magnet 10 and the OIS coil 13 in the left side is in a state where the polarized surface 10a of the permanent magnet 10 and the winding axis 13a of the OIS coil 13 are in the same plane as illustrated in FIG. 7. On the other hand, the positional relation of the permanent magnet 10 and the OIS coil 13 in the right side is in a state where the position of the OIS coil 13 is deviated to the side of the center of gravity G of the OIS movable portion with respect to the permanent magnet 10.

Accordingly, the component 25a in the vertical direction of the reaction force 25 which acts on the lower end surface of the permanent magnet 10 in the right side generates rotational torque T2a′ which is clockwise. In addition, rotational torque T2b′ which is counterclockwise is generated on the basis of each of the components 25b in the horizontal direction, which acts on each of the both permanent magnets 10. Since the rotational torque T2a′ acts in a direction of offsetting the rotational torque T2b′, rotational torque T2′ which is counterclockwise acts on the center of gravity G of the OIS movable portion in the end.

Note that, when the OIS hall element 14 is arranged so as to face the lower surface of the permanent magnet 10 in the right side, there is a possibility that the OIS hall element 14 detects also displacement in the direction of the optical axis 4a in the state after OIS drive. However, there is no other choice, and it is desired that the OIS hall element 14 is arranged in the side in which the position of the OIS coil 13 is not deviated to the center of gravity G of the OIS movable portion with respect to the permanent magnet 10, only in a state where the OIS movable portion is at a neutral position before OIS drive.

This is because, for example, in a case where the OIS movable portion is displaced in a direction opposite to the direction illustrated in FIG. 7, a displacement amount in the direction of the optical axis 4a is further increased compared with a case of the positional relation of the permanent magnets 10 and the OIS coils 13, which is illustrated in FIG. 6, and, when the OIS hall element 14 is arranged so as to face the lower surface of the permanent magnet 10 in the left side at this time, the OIS hall element 14 is to detect more displacement in the direction of the optical axis 4a, which is not to be detected originally.

That is, in order to uniformly reduce detection of displacement in the direction of the optical axis 4a, it is desired that the OIS hall element 14 is arranged as described above.

### Embodiment 3

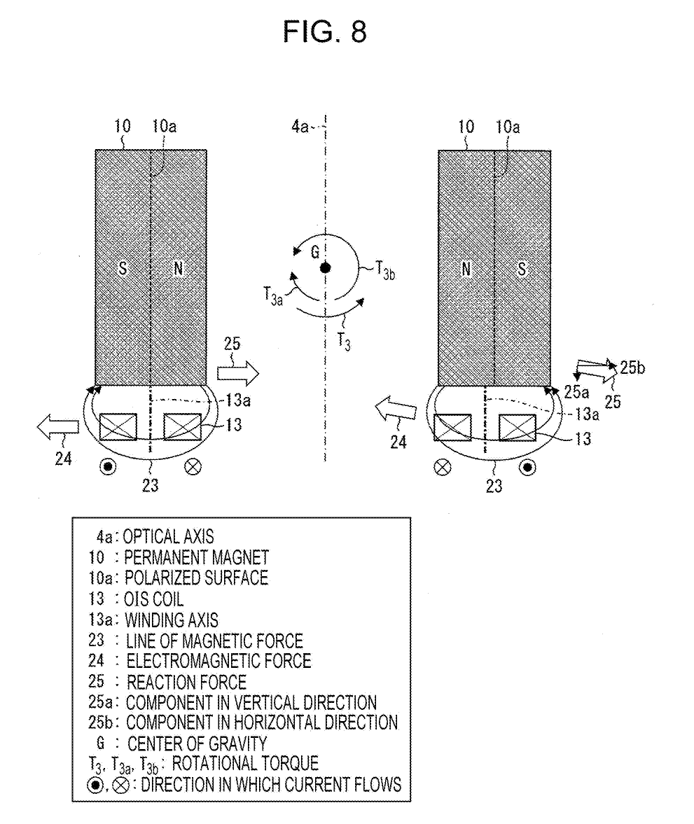

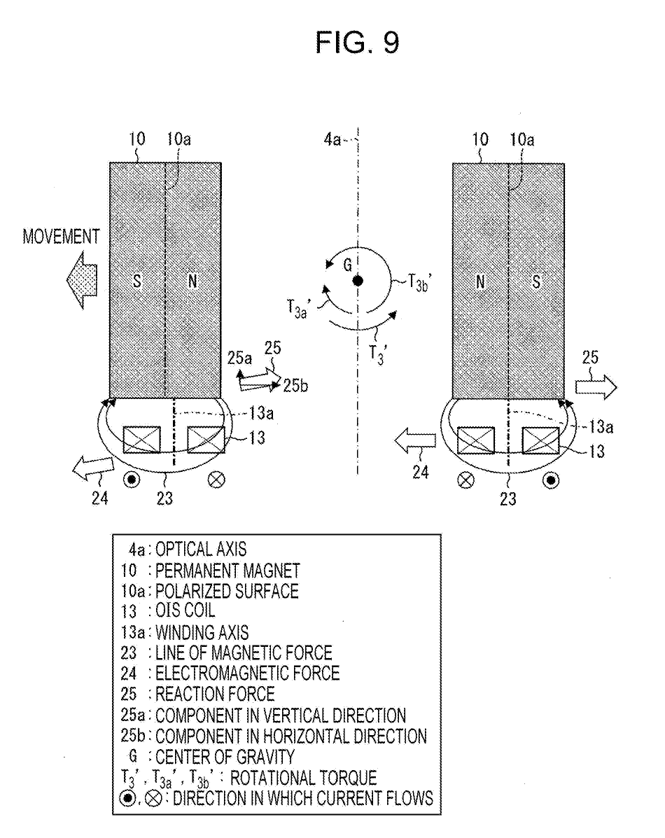

Another embodiment of the invention will be described as follows on the basis of FIG. 8 and FIG. 9. Note that, for convenience of description, the same reference signs will be assigned to members having the same functions as those of the members described in each of the aforementioned embodiments, and description thereof will be omitted.

### <Positional Relation of Permanent Magnets and OIS Coils>

Hereinafter, a positional relation of the permanent magnets 10 and the OIS coils 13 which are included in the camera module 50 according to Embodiment 3 of the invention will be described with reference to FIG. 8. FIG. 8 is a cross sectional view of a main part, which illustrates an example of the positional relation of a pair of permanent magnets 10 and the OIS coils 13 which are included in the camera module 50 according to the present embodiment. Moreover, FIG. 9 is a cross sectional view of the main part, which illustrates a state in which the pair of permanent magnets 10 are displaced in a direction of an arrow in the figure from the positional relation illustrated in FIG. 8.

The camera module 50 according to the present embodiment is different from the camera module 50 according to each of Embodiments 1 and 2 in that, as illustrated in FIG. 8, the winding axis 13a of the OIS coil 13 is deviated to the side of the center of gravity G of the OIS movable portion with respect to the polarized surface 10a of the permanent magnet 10 only in the permanent magnet 10 and the OIS coil 13 in the right side. Moreover, the present embodiment is different from Embodiment 2 in that the position of the OIS coil 13 is deviated to the center of gravity G with respect to the permanent magnet 10 not in the left side but in the right side.

Accordingly, between the camera module 50 according to the present embodiment and the camera module 50 according to Embodiment 2, a right-and-left relation is merely inversed, and the camera module 50 according to the present embodiment has an improvement principle of the servo performance of the OIS driving portion, which is similar to that of the camera module 50 according to Embodiment 2, so that detailed description thereof will be omitted.

Note that, in a configuration of the camera module 50 according to the present embodiment, it is desired that the OIS hall element 14 is arranged so as to face the lower surface of the permanent magnet 10 in the left side.

### Embodiment 4

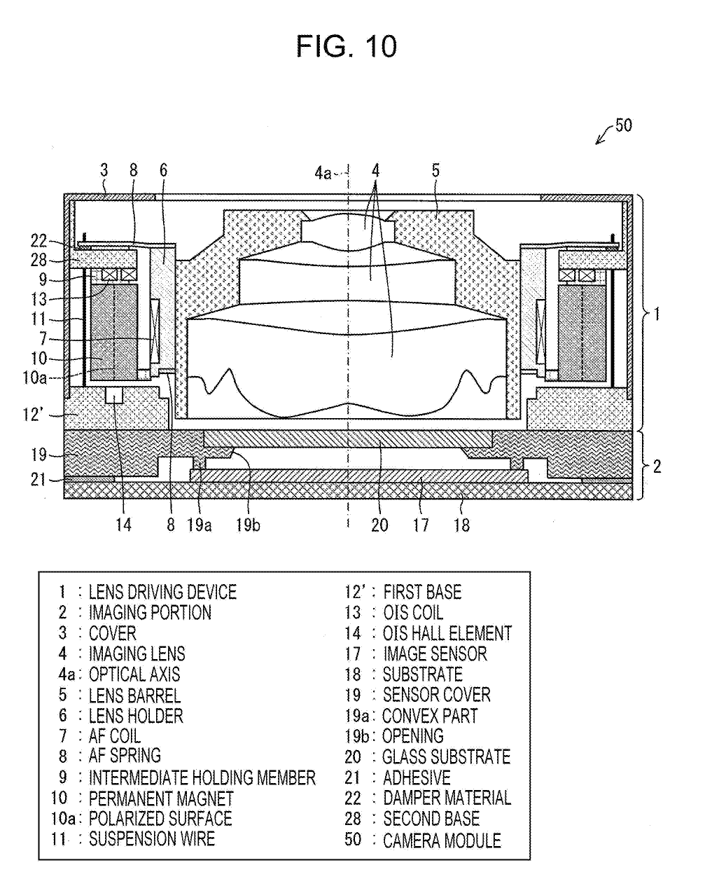

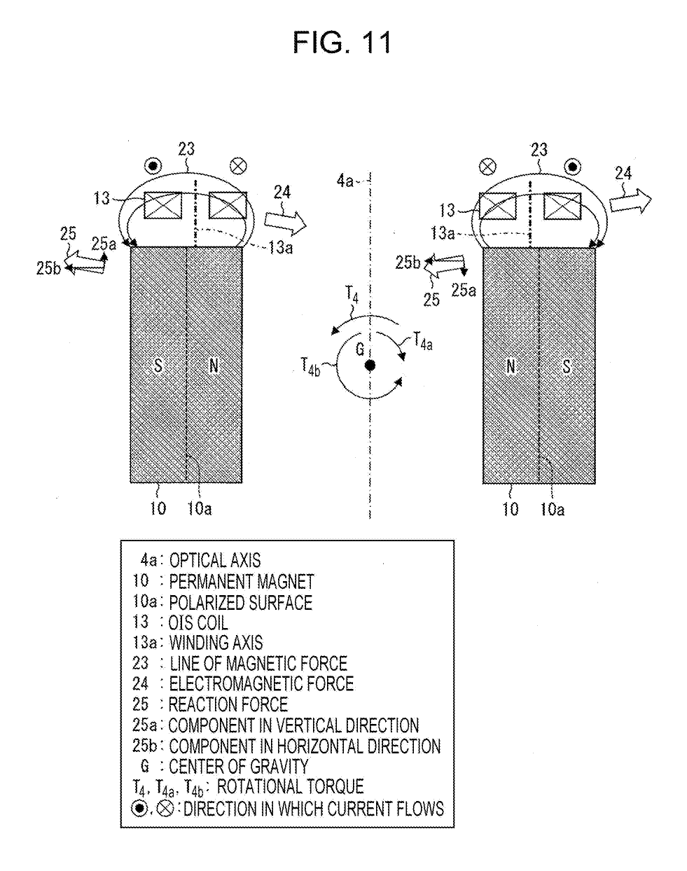

Another embodiment of the invention will be described as follows on the basis of FIG. 10 and FIG. 11. Note that, for convenience of description, the same reference signs will be assigned to members having the same functions as those of the members described in each of the aforementioned embodiments, and description thereof will be omitted.

### <Configuration of Camera Module>

First, a structure of each portion of the camera module 50 according to Embodiment 4 of the invention will be described on the basis of FIG. 10. FIG. 10 is a cross sectional view schematically illustrating a schematic configuration of the camera module 50 according to the present embodiment. Note that, FIG. 10 corresponds to a cross sectional view of the camera module 50 illustrated in FIG. 1, which is taken along the A-A line and viewed from the direction of arrows.

The camera module 50 according to the present embodiment is different from the camera module 50 according to each of Embodiments 1 to 3 in that, as illustrated in FIG. 10, each of the pair of OIS coils 13 is arranged so as to face an upper surface of each of the permanent magnets 10. Note that, similarly to the camera module 50 according to each of Embodiments 1 to 3, the OIS hall element 14 is arranged so as to face the lower surface of the permanent magnet 10.

In a case where the OIS coils 13 are arranged in such a manner, in order to fix the OIS coils 13, a second base 28 is provided in addition to a first base 12′ (which has a shape and a function similar to those of the base 12). The second base 28 is provided to protrude to an inner side of the cover 3 so as to be arranged in a region between the upper AF spring 8 and the intermediate holding member 9. The OIS coils 13 are fixed to a lower surface of the second base 28.

By arranging the OIS coils 13 in an upper side of the permanent magnets 10 in this manner, it is possible to bring the OIS hall element 14 closer to the permanent magnet 10, thus making it possible to enhance sensitivity of displacement detection of the OIS hall element 14. Moreover, the OIS hall element 14 becomes less likely to be affected by magnetic field noise which is generated when current is applied to the OIS coil 13.

### <Positional Relation of Permanent Magnets and OIS Coils>

Next, a positional relation of the permanent magnets 10 and the OIS coils 13 which are included in the camera module 50 according to the present embodiment will be described with reference to FIG. 11. FIG. 11 is a cross sectional view of a main part, which illustrates an example of the positional relation of a pair of permanent magnets 10 and the OIS coils 13 which are included in the camera module 50 according to the present embodiment.

As illustrated in FIG. 11, it is desired that the OIS coils 13 are arranged so that each of the winding axes 13a of the OIS coils 13 is deviated to the side of the center of gravity G of the OIS movable portion with respect to each of the polarized surfaces 10a of the permanent magnets 10 even when each of the pair of OIS coils 13 is arranged in the upper side of each of the permanent magnets 10.

In a case where, in the positional relation of the pair of permanent magnets 10 and the OIS coils 13 illustrated in FIG. 11, current is applied in a direction illustrated in the figure, the components 25b in the horizontal direction, each of which acts on each of the pair of permanent magnets 10, generates rotational torque T4b which acts counterclockwise about the center of gravity G. At the same time, as if to offset the rotational torque T4b, the components 25a in the vertical direction, each of which acts on each of the pair of permanent magnets 10, generates rotational torque T4a, which acts clockwise about the center of gravity G, in the same manner. Rotational torque T4 which has been reduced at a certain degree by an offset effect of the rotational torque T4b and the rotational torque T4a acts on the center of gravity G of the OIS movable portion in the end.

Thus, it is possible to reduce a resonance peak of a resonance phenomenon of the rotation mode, which is generated in the OIS movable portion.

### Embodiment 5

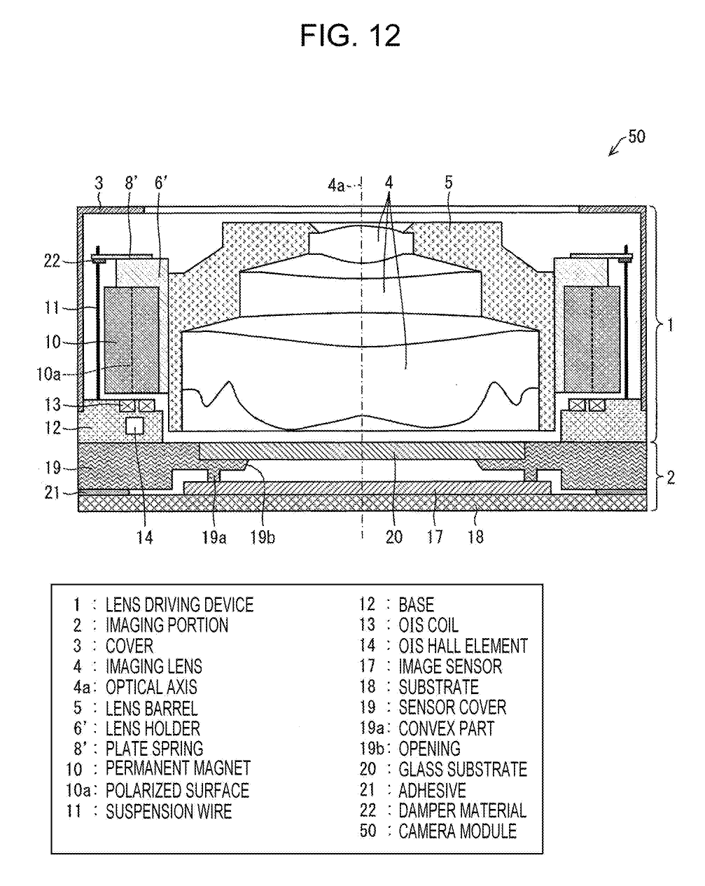

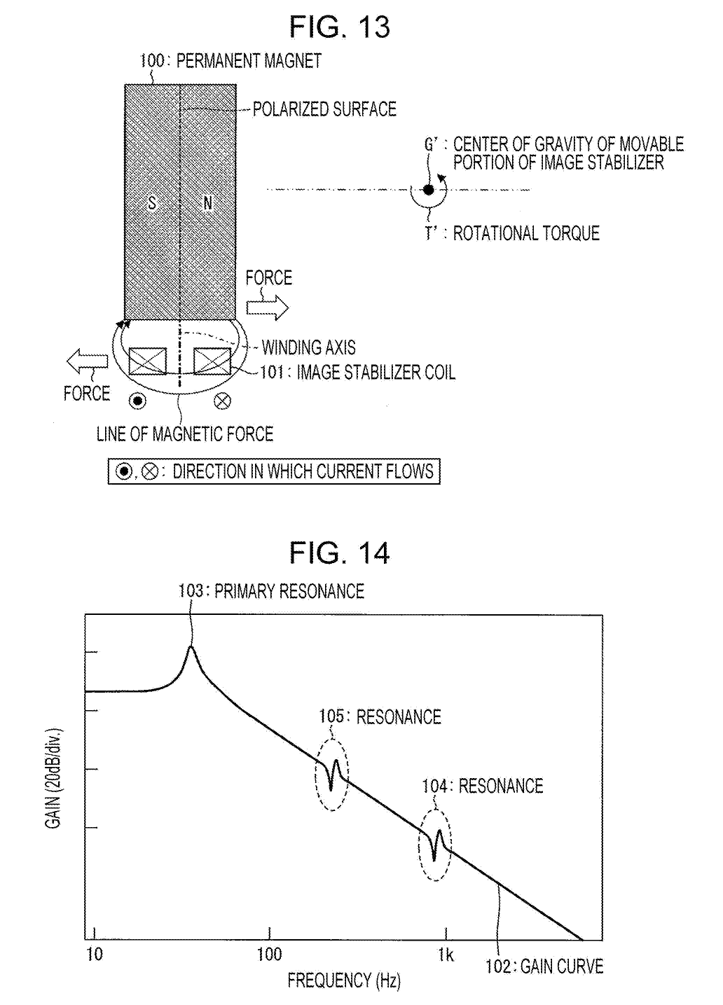

Another embodiment of the invention will be described as follows on the basis of FIG. 12. Note that, for convenience of description, the same reference signs will be assigned to members having the same functions as those of the members described in each of the aforementioned embodiments, and description thereof will be omitted.

### <Configuration of Camera Module>

Hereinafter, a structure of each portion of the camera module 50 according to Embodiment 5 of the invention will be described on the basis of FIG. 12. FIG. 12 is a cross sectional view schematically illustrating a schematic configuration of the camera module 50 according to the present embodiment. Note that, FIG. 12 corresponds to a cross sectional view of the camera module 50 illustrated in FIG. 1, which is taken along the A-A line and viewed from the direction of arrows.

As illustrated in FIG. 12, the camera module 50 according to the present embodiment is different from the camera module 50 according to each of Embodiments 1 to 4 in that none of the AF coil 7, the AF spring 8, and the intermediate holding member 9 is included and the imaging lenses 4 are fixed-focus lenses.

Moreover, in the camera module 50 according to the present embodiment, a lens holder 6′ also has a function as the intermediate holding member 9. Accordingly, the permanent magnets 10 are fixed to the lens holder 6′ so as to have the lower surfaces thereof facing the OIS coils 13.

Note that, the extending parts 8a of the AF spring 8, which are included in the camera module 50 according to each of Embodiments 1 to 4, also function as shock absorbers which are used for protection of the suspension wires 11. Since the camera module 50 according to the present embodiment also includes the suspension wires 11, a plate spring 8′ having the extending parts 8a is fixed to an upper surface of the lens holder 6′ in place of the AF spring 8. Then, the upper end of each of the suspension wires 11 is fixed to each of the extending parts 8a.

As above, according to the present embodiment, the AF driving portion is not necessary, so that it is possible to simplify a configuration of the imaging lenses 4 in the direction vertical to the optical axis 4a. Thus, it is possible to achieve both improvement of accuracy of image stabilization and miniaturization of the camera module 50.

### Conclusion

A camera module (50) according to an aspect 1 of the invention includes: an imaging lens (4); and a driving portion that moves the imaging lens in a direction vertical to an optical axis (4a), in which the driving portion includes a movable portion on which the imaging lens is mounted and a fixed portion (base 12, first base 12′, second base 28) which is not displaced at a time of image stabilization, a permanent magnet (10) is included in one of the movable portion and the fixed portion and a coil (OIS coil 13) is included in the other, one magnetic pole of the permanent magnet faces the optical axis, a surface of the coil, which is orthogonal to a winding axis (13a) of the coil, faces a surface of the permanent magnet, which is orthogonal to a polarized surface (10a) of the permanent magnet and substantially vertical to the optical axis, in parallel, and the coil is arranged so as to be deviated to a side of a center of gravity (G) of the movable portion with the polarized surface as a reference.

With the aforementioned configuration, the camera module includes the driving portion that moves the imaging lens in the direction vertical to the optical axis, and the driving portion includes the movable portion on which the imaging lens is mounted and the fixed portion which is not displaced at the time of image stabilization. Moreover, the permanent magnet is included in one of the movable portion and the fixed portion and the coil is included in the other. Furthermore, one magnetic pole of the permanent magnet faces the optical axis, and the surface of the coil, which is orthogonal to the winding axis of the coil, faces the surface of the permanent magnet, which is orthogonal to the polarized surface of the permanent magnet and substantially vertical to the optical axis, in parallel.

When current is applied to the coil in such a positional relation of the permanent magnet and the coil, an electromagnetic force in a direction substantially vertical to the optical axis acts on the coil in accordance with Fleming's left-hand rule. Here, in a case where the coil is fixed to the fixed portion, force in a direction opposite to the electromagnetic force acts on the permanent magnet in a vicinity of a surface of the permanent magnet, which is on a side facing the coil, due to reaction of the electromagnetic force. Accordingly, rotational torque acts on the driving portion around the center of gravity of the movable portion. Then, a resonance phenomenon occurs in the movable portion due to the action of the rotational torque, and servo performance of the driving portion is deteriorated.

In this respect, with the aforementioned configuration, in the camera module, the coil is arranged so as to be deviated to the side of the center of gravity of the movable portion with the polarized surface as the reference. Accordingly, a large number of magnetic flux components which are inclined with respect to the polarized surface enter a part of the coil, which is in the side of the center of gravity from the winding axis, compared with other parts. Therefore, an electromagnetic force which acts in a direction inclined with respect to a direction of the optical axis is generated in the coil, and force which acts on the permanent magnet in a case where the coil is fixed is also generated in a direction inclined with respect to the direction vertical to the optical axis.

In this case, between rotational torque which acts around the center of gravity of the movable portion by a component of the force acting on the permanent magnet, which is in the direction vertical to the optical axis, and rotational torque which acts around the center of gravity by a component of the force acting on the permanent magnet, which is in the direction of the optical axis, rotation directions are opposite to each other. Thus, rotation torque is offset at least at a certain degree, so that it is possible to reduce a resonance peak of a resonance phenomenon which occurs as a result of rotational torque.

As above, it is possible to provide a camera module capable of performing image stabilization with high accuracy by improvement of servo performance by reducing a resonance peak.

The camera module (50) according to an aspect 2 of the invention may have a configuration in which, in the aspect 1, a pair of permanent magnets (10) and a pair of coils (OIS coils 13) are provided so as to correspond to one movement direction of the driving portion, and each of the pair of coils is arranged so as to be deviated to the side of the center of gravity (G) of the movable portion with the polarized surface (10a) as the reference.

With the aforementioned configuration, the pair of permanent magnets and the pair of coils are provided so as to correspond to one movement direction of the driving portion. Therefore, compared with a case where one permanent magnet and one coil are provided so as to correspond to the movement direction, driving force of the driving portion (in the case where the coil is fixed, force acting on the permanent magnet) becomes twice, so that the servo performance of the driving portion is further improved.

Moreover, with the aforementioned configuration, each of the pair of coils is arranged so as to be deviated to the side of the center of gravity of the movable portion with the polarized surface of the facing permanent magnet as the reference. Here, in a case where each of the pair of coils is fixed to the fixed portion, rotational torque which acts around the center of gravity by a component of force acting on the permanent magnet, which is in the direction of the optical axis, becomes twice compared with a case where only either of the pair of coils is arranged so as to be deviated to the side of the center of gravity with the polarized surface as the reference. Thus, an offset effect by two types of rotational torque which are opposite to each other is improved, so that it is possible to further reduce occurrence of rotational torque which causes a resonance phenomenon.

The camera module (50) according to an aspect 3 of the invention may have a configuration in which, in the aspect 1, a displacement detection portion (OIS hall element 14) that detects a displacement amount of the imaging lens (4) in the direction vertical to the optical axis (4a) is further included, a pair of permanent magnets (10) and a pair of coils (OIS coils 13) are provided so as to correspond to one movement direction of the driving portion, and one of the pair of coils is arranged so as to be deviated to the side of the center of gravity (G) of the movable portion with the polarized surface (10a) as the reference, and the displacement detection portion is arranged so as to face the permanent magnet arranged in a side opposite to the one of the pair of coils with the center of gravity of the movable portion as a reference.

With the aforementioned configuration, the pair of permanent magnets and the pair of coils are provided so as to correspond to one movement direction of the driving portion, and one of the pair of coils is arranged so as to be deviated to the side of the center of gravity of the movable portion with the polarized surface of the facing permanent magnet as the reference.

Here, in a case where only one of the pair of coils is arranged so as to be deviated to the side of the center of gravity of the movable portion with the polarized surface of the facing permanent magnet as the reference, a component of force acting on the permanent magnet, which is in the direction of the optical axis, becomes half compared with a case where each of the pair of coils is arranged so as to be deviated to the side of the center of gravity with the polarized surface as the reference. Therefore, it is possible to reduce a resonance peak of a resonance phenomenon which occurs near a connecting point of the suspension wire and the AF spring, for example, on the basis of the component in the direction of the optical axis, and servo performance of the camera module is improved.

Moreover, with the aforementioned configuration, the displacement detection portion that detects the displacement amount of the imaging lens in the direction vertical to the optical axis is included so as to face the permanent magnet arranged in the side opposite to the one of the pair of coils with the center of gravity of the movable portion as the reference.

Here, in the case where each of the pair of coils is fixed to the fixed portion, the component in the direction of the optical axis does not act on the permanent magnet arranged in the side opposite to the one of the pair of coils, so that a displacement amount thereof in the direction of the optical axis is less than that of the other permanent magnet on which the component directly acts.

Therefore, compared with a case where the displacement detection portion is arranged so as to face the permanent magnet arranged on a side of the one of the pair of coils with the center of gravity of the movable portion as the reference, it is possible to lower an erroneous displacement detection signal level resulting from detection of displacement of the permanent magnet in the direction of the optical axis. Thus, the camera module is able to detect displacement of the imaging lens in the direction vertical to the optical axis with high accuracy.

The camera module (50) according to an aspect 4 of the invention may have a configuration in which, in any of the aspects 1 to 3, the permanent magnet (10) is included in the movable portion.

Since the imaging lens is mounted on the movable portion, in a case where the coil is included in the movable portion, it is difficult to arrange the coil so as to be closer to the side of the center of gravity of the movable portion compared with a case where the coil is fixed to the fixed portion.

In this respect, with the aforementioned configuration, the permanent magnet is included in the movable portion. Accordingly, the coil is included in the fixed portion, so that it is possible to arrange the coil so as to be closer to the side of the center of gravity. Therefore, it is possible to further increase a component of force acting on the permanent magnet, which is in the direction vertical to the optical axis, and the offset effect by two types of rotational torque which are opposite to each other is improved. This makes it possible to further reduce occurrence of rotational torque which causes a resonance phenomenon.

Moreover, by fixing the displacement detection portion to the fixed portion, it is possible to facilitate carrying current to the coil and the displacement detection portion compared with a case where the coil and the displacement detection portion are included in the movable portion. Furthermore, in a case where the camera module has an AF function, it is possible to use the permanent magnet as a magnet which is common for AF and OIS, thus making it possible to achieve reduction in the number of parts.

The camera module (50) according to an aspect 5 of the invention may have a configuration in which, in any of the aspects 1 to 4, a damper material (22) that suppresses vibrations of the movable portion is further included.

With the aforementioned configuration, the camera module includes the damper material. Accordingly, by providing the damper material, for example, near the connecting point of the suspension wire and the AF spring or the like, it is possible to suppress the vibrations of the movable portion, which are generated as a result of a resonance phenomenon. It is therefore possible to further reduce a resonance peak of a resonance phenomenon which occurs in the movable portion, and the servo performance of the driving portion is further improved.

The camera module (50) according to an aspect 6 of the invention may have a configuration in which, in the aspect 3, a surface of the permanent magnet (10), which faces the coil (OIS coil 13), and a surface of the permanent magnet, which faces the displacement detection portion (OIS hall element 14), are different.

With the aforementioned configuration, the surface of the permanent magnet, which faces the coil, and the surface of the permanent magnet, which faces the displacement detection portion, are different. Accordingly, in the configuration, the coil does not lie between the displacement detection portion and the surface of the permanent magnet, which faces the displacement detection portion, so that it is possible to bring the displacement detection portion closer to the permanent magnet compared with a case where the coil lies therebetween. It is therefore possible to enhance sensitivity of displacement detection of the displacement detection portion and reduce influence on the displacement detection portion, which is exerted by magnetic field noise that is generated when current is applied to the coil.

The invention is not limited to each of the embodiments described above and may be modified in various manners within the scope of the claims, and an embodiment achieved by appropriately combining technical means disclosed in different embodiments is also encompassed in the technical scope of the invention. Further, by combining the technical means disclosed in each of the embodiments, a new technical feature may be formed.

### REFERENCE SIGNS LIST

4 imaging lens
4a optical axis
5 lens barrel (movable portion)
6 lens holder (movable portion)
7 AF coil (movable portion)
9 intermediate holding member (movable portion)
10 permanent magnet (movable portion)
10a polarized surface
12 base (fixed portion)
13 OIS coil (coil)
13a winding axis
14 OIS hall element (displacement detection portion)
22 damper material
50 camera module

1: A camera module, comprising:
an imaging lens; and
a driving portion that moves the imaging lens in a direction vertical to an optical axis, wherein
the driving portion includes a movable portion on which the imaging lens is mounted and a fixed portion which is not displaced at a time of image stabilization,
a permanent magnet is included in one of the movable portion and the fixed portion and a coil is included in the other one of the movable portion and the fixed portion,
one magnetic pole of the permanent magnet faces the optical axis,
a surface of the coil, which is orthogonal to a winding axis of the coil, faces a surface of the permanent magnet, which is orthogonal to a polarized surface of the permanent magnet and substantially vertical to the optical axis, in parallel,
the coil is arranged to be deviated to a side of a center of gravity of the movable portion with the polarized surface as a reference, and
at least part of a portion of the coil which portion is arranged on the side of the center of gravity of the movable portion faces the permanent magnet.

2: The camera module according to claim 1, wherein a pair of permanent magnets, each of which is the permanent magnet, and a pair of coils, each of which is the coil, are provided to correspond to one movement direction of the driving portion, and each of the pair of coils is arranged to be deviated to the side of the center of gravity of the movable portion with the polarized surface as the reference.

3: The camera module according to claim 1, further comprising
a displacement detection portion that detects a displacement amount of the imaging lens in the direction vertical to the optical axis, wherein
a pair of permanent magnets, each of which is the permanent magnet, and a pair of coils, each of which is the coil, are provided to correspond to one movement direction of the driving portion, and one of the pair of coils is arranged to be deviated to the side of the center of gravity of the movable portion with the polarized surface as the reference, and
the displacement detection portion is arranged to face the permanent magnet arranged in a side opposite to the one of the pair of coils with the center of gravity of the movable portion as a reference.

4: The camera module according to claim 1, wherein the permanent magnet is included in the movable portion.

5: The camera module according to claim 1, further comprising a damper material that suppresses vibrations of the movable portion.
